(19) United States
(12) Patent Application Publication
(10) Pub. No.: US 2024/0083454 A1
(43) Pub. Date: Mar. 14, 2024

(54) VEHICLE CONTROL SYSTEM AND VEHICLE CONTROL METHOD

(71) Applicant: Toyota Jidosha Kabushiki Kaisha, Toyota-shi Aichi-ken (JP)

(72) Inventor: Yoshiyuki Takeuchi, Susono-shi Shizuoka-ken (JP)

(73) Assignee: TOYOTA JIDOSHA KABUSHIKI KAISHA, Toyota-shi Aichi-ken (JP)

(21) Appl. No.: 18/463,341

(22) Filed: Sep. 8, 2023

(30) Foreign Application Priority Data
Sep. 12, 2022 (JP) 2022-144805

(51) Int. Cl. B60W 60/00; B60W 30/14; B60W 30/18

(52) U.S. Cl. CPC B60W 60/001; B60W 30/146; B60W 30/18163; B60W 2520/00; B60W 2554/80

(57) ABSTRACT

The present disclosure relates to a vehicle control system for controlling a vehicle that performs autonomous driving. A first lane is a traffic lane in which the vehicle travels. A second lane is a traffic lane adjacent to the first lane in a lane change section of less than a predetermined distance. A lane change between the first lane and the second lane is permitted in the lane change section. The vehicle control system decelerates the vehicle before the lane change section when the lane change section is present in front of the vehicle and a deceleration condition is satisfied during the autonomous driving of the vehicle. The deceleration condition includes at least a terrain condition that a target-invisible section in which the second lane is invisible from the vehicle is present before the lane change section.

### CROSS-REFERENCE TO RELATED APPLICATION

The present application claims priority under 35 U.S.C. § 119 to Japanese Patent Application No. 2022-144805, filed Sep. 12, 2022, the contents of which application are incorporated herein by reference in their entirety.

### BACKGROUND

### Field

The present disclosure relates to a technique for controlling a vehicle that performs autonomous driving.

### Background Art

WO 2019/064350 discloses a technique related to a vehicle that is a target of autonomous driving by an autonomous driving system. According to this technique, a point connected to another lane on a traveling route planned for the vehicle is extracted as a high difficulty point at which the autonomous driving is difficult. Then, at a point a predetermined distance before the high difficulty point, the driver is guided to switch from the autonomous driving to manual driving.

In addition to WO 2019/064350, JP 2015-153153A discloses a technique related to a control by autonomous driving at a point where a lane in which a vehicle travels and another lane merge.

### SUMMARY

A lane in which a vehicle that performs autonomous driving travels is referred to as a first lane. A section in which a lane change between the first lane and a second lane is permitted within a predetermined distance is referred to as a lane change section. In the lane change section, another vehicle traveling in the second lane can change merge into the first lane. Therefore, the autonomous driving system needs to determine whether to decelerate a target vehicle such that the other vehicle can change lanes ahead of the target vehicle or to maintain a speed such that the other vehicle can change lanes behind the target vehicle. If the determination is not made in time before the end of the lane change section, there is a possibility that the target vehicle and the other vehicle continue to travel side by side until the end of the lane change section, which can inhibit an appropriate lane change.

A technique of the present disclosure is made in view of the above mentioned problem. An object of the present disclosure is to provide a technique capable of promoting an appropriate lane change when there is a lane change section in a lane in which a vehicle that performs autonomous driving travels.

A first aspect of the present disclosure relates to a vehicle control system for controlling a vehicle that performs autonomous driving. The vehicle control system comprising one or more processors. A first lane is a traffic lane in which the vehicle travels. A second lane is a traffic lane adjacent to the first lane in a lane change section of less than a predetermined distance. A lane change between the first lane and the second lane is permitted in the lane change section. The one or more processors are configured to decelerate the vehicle before the lane change section when the lane change section is present in front of the vehicle and a deceleration condition is satisfied during the autonomous driving of the vehicle. The deceleration condition includes at least a terrain condition that a target-invisible section in which the second lane is invisible from the vehicle is present before the lane change section.

A second aspect of the present disclosure relates to a vehicle control method for controlling a vehicle that performs autonomous driving. A first lane is a traffic lane in which the vehicle travels. A second lane is a traffic lane adjacent to the first lane in a lane change section of less than a predetermined distance. A lane change between the first lane and the second lane is permitted in the lane change section. The vehicle control method comprises decelerating the vehicle before the lane change section when the lane change section is present in front of the vehicle and a deceleration condition is satisfied during the autonomous driving of the vehicle. The deceleration condition includes at least a terrain condition that a target-invisible section in which the second lane is invisible from the vehicle is present before the lane change section.

According to the technique of the present disclosure, when a lane change section is present in front of a vehicle which performs autonomous driving and a deceleration condition is satisfied, the vehicle is controlled so as to decelerate before the lane change section. As a result, time needed by the vehicle to travel from the start to the end of the lane change section increases. Therefore, while the vehicle passes through the lane change section, various kinds of determination can be made with a margin. Even if it becomes clarified that another vehicle is present in an adjacent lane after the vehicle gets to the lane change section, it is possible to determine how to control the vehicle to realize an appropriate lane change with a margin. That is, it is possible to promote the appropriate lane change when the lane change section is present in the lane in which the vehicle travels.

### BRIEF DESCRIPTION OF THE DRAWINGS

FIG. 1 is a diagram for explaining the problem.

FIG. 2 is a diagram for explaining an example of a lane change section.

FIG. 3 is a block diagram showing a configuration example of a vehicle control system according to an embodiment.

FIG. 4 is a block diagram showing an example of driving environment information according to the embodiment.

FIG. 5 is a flowchart showing processing relating to advance deceleration control by the vehicle control system according to the embodiment.

FIG. 6 is a diagram for explaining an example of a target-invisible section.

FIG. 7A is a diagram for explaining another example of the target-invisible section.

FIG. 7B is a diagram for explaining another example of the target-invisible section.

FIG. 8 is a flowchart showing an example of processing by the vehicle control system according to a first embodiment.

FIG. 9 is a flowchart showing an example of processing by the vehicle control system according to a second embodiment.

FIG. 10 is a flowchart showing an example of processing by the vehicle control system according to a third embodiment.

FIG. 11 is a flowchart showing an example of processing by the vehicle control system according to a fourth embodiment.

FIG. 12 is a flowchart showing an example of processing by the vehicle control system according to a fifth embodiment.

FIG. 13 is a diagram showing time charts for explaining an effect of the advance deceleration control by the vehicle control system.

### DETAILED DESCRIPTION

Embodiments of the present disclosure will be described with reference to the accompanying drawings.

### 1. Overview

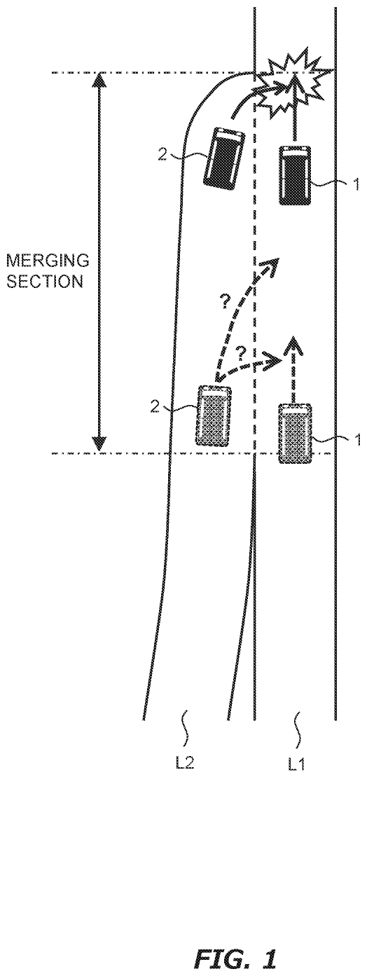

FIG. 1 is a diagram for explaining a problem related to a vehicle 1, which has an autonomous driving function. The vehicle 1 is travelling in a first lane L1 by the autonomous driving. The first lane L1 has a merging section where a second lane L2 merges with the first lane L1. In the merging section, a vehicle 2, which is travelling in the second lane L2, changes lanes and merges into the first lane L1. An autonomous driving system which performs autonomous driving of the vehicle 1 needs to determine whether to overtake the vehicle 2 or yield to the vehicle 2 by decelerating the vehicle 1 and needs to control the vehicle 1 in accordance with the determination. If the autonomous driving system is given insufficient time for determination and control, there is a possibility that the autonomous driving system cannot perform control in time and the vehicle 1 and the vehicle 2 continue to travel side by side until the vehicle 1 reaches the end of the merging section. It may prevent an appropriate lane change. For example, it may cause an unreasonable lane change of the vehicle 2 from the viewpoint of safety. Further, in some cases, the driver is urgently required to operate the vehicle 1 as a result of the unreasonable lane change.

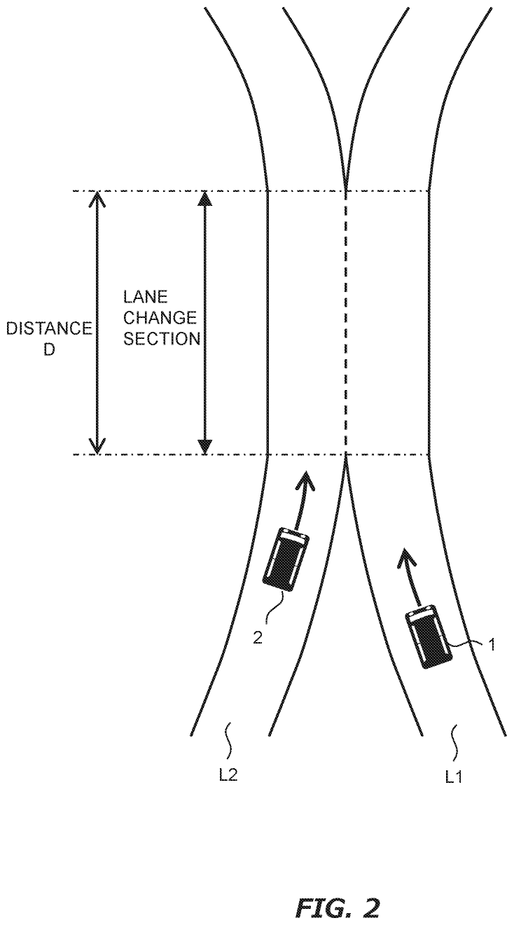

A terrain where these problems may occur is not limited to the merging section shown in FIG. 1. For example, when the first lane L1 and the second lane L2 have a positional relationship as shown in FIG. 2, there is a possibility that the vehicle 2 traveling in the second lane L2 changes lanes and merges into the first lane L1. A similar problem may occur in this case.

In general, when there is a section of less than a predetermined distance in which the lane change between the first lane L1 and the second lane L2 is permitted, a similar problem may occur. Such a section where the lane change between the first lane L1 and the second lane L2 is permitted is hereinafter referred to as a “lane change section”. The distance (length) of the lane change section is hereinafter referred to as a distance D. The first lane L1 and the second lane L2 are adjacent to each other at least in the lane change section. The lane change section includes the merging section shown in FIG. 1 and the section shown in FIG. 2.

In order to prevent the control by the autonomous driving system from becoming too late, switching the autonomous driving to manual driving before the lane change section can be considered as one method. However, if the driver is requested to start manual driving every time a lane change section appears, it may cause the driver to feel annoyed and cause the loss of convenience of the autonomous driving.

The vehicle control system according to the present embodiment is made in view of the above problem. The vehicle control system is applied to the vehicle 1 and controls the vehicle 1. Typically, the vehicle control system is mounted on the vehicle 1. Alternatively, at least a part of the vehicle control system may be mounted on an external device outside the vehicle 1 and remotely control the vehicle 1.

The vehicle control system sets a predetermined condition as a deceleration condition. Then, when the lane change section is present in front of the vehicle 1 under the autonomous driving and the deceleration condition is satisfied, the vehicle control system decelerates the vehicle 1 before the lane change section. This control is referred to as “advance deceleration control”. By the advance deceleration control, the time needed by the vehicle 1 to travel from the start to the end of the lane change section increases. Therefore, it becomes possible for the vehicle control system to perform various kinds of determination with a margin while the vehicle 1 passes through the lane change section. Even if it becomes clear that the vehicle 2 is present in the second lane L2 after the vehicle 1 reaches the lane change section, it becomes possible for the vehicle control system to determine how to control the vehicle 1 in order to realize an appropriate lane change with a margin. That is, it becomes possible to promote the appropriate lane change when the first lane L1 in which the autonomously driven vehicle 1 travels has the lane change section. In addition, it is possible to reduce a risk of contact between the vehicle 1 and the vehicle 2 and realize safe driving of the vehicle 1.

The autonomous driving function of the vehicle 1 is, for example, an autonomous driving function of level 3 or higher which does not require the driver's thorough concentration on driving. The autonomous driving function of the vehicle 1 may include a driving support function which presupposes the driver's driving such as an adaptive cruise control (ACC) or a lane keeping assist (LKA). The vehicle control system may include an autonomous driving system of vehicle 1.

### 2. Example of Configuration

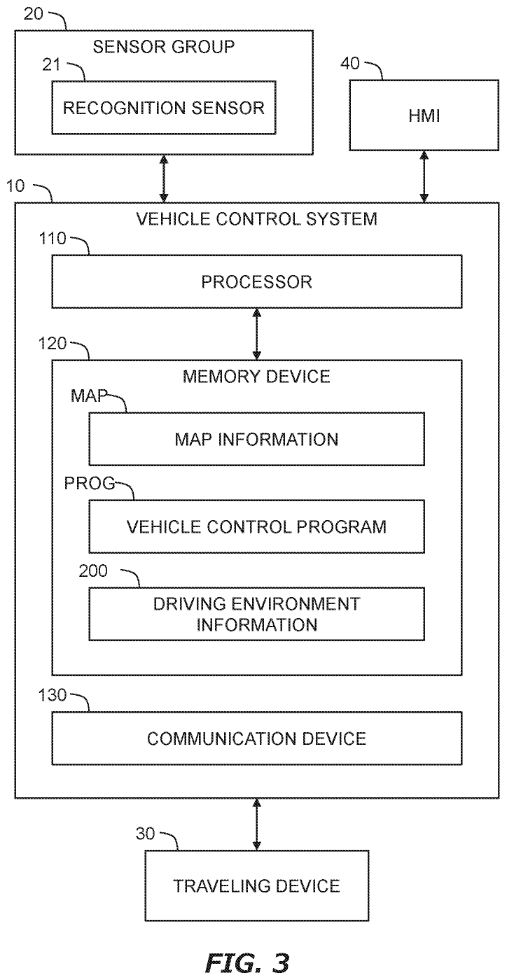

FIG. 3 is a block diagram illustrating an example of a configuration of a vehicle control system 10 according to the present embodiment. The vehicle control system 10 includes one or more processors 110 (hereinafter simply referred to as a processor 110), one or more memory devices 120 (hereinafter simply referred to as a memory device 120), and a communication device 130. The processor 110 executes various processes. For example, the processor 110 includes a central processing unit (CPU). The memory device 120 stores various kinds of information. Examples of the memory device 120 include a volatile memory, a nonvolatile memory, a hard disk drive (HDD), a solid state drive (SSD). The communication device 130 communicates with the outside of the vehicle 1. The vehicle control system 10 may include one or more electronic control units (ECUs).

The vehicle control system 10 is configured to be able to communicate with a sensor group 20, a traveling device 30, and a human machine interface (HMI) 40, which are mounted on the vehicle 1.

The sensor group 20 includes a recognition sensor 21 that recognizes (detects) a situation around the vehicle 1. Examples of the recognition sensor 21 include a camera, a laser imaging detection and ranging (LIDAR), and a radar.

The sensor group 20 includes a vehicle state sensor that detects a state of the vehicle 1. The vehicle state sensor includes a speed sensor, an acceleration sensor, a yaw rate sensor, a steering angle sensor, and the like. Further, the sensor group 20 includes a position sensor that detects a position and a direction of the vehicle 1. As the position sensor, a global positioning system (GPS) sensor is exemplified.

The traveling device 30 includes a steering device, a driving device, and a braking device. The steering device steers wheels. For example, the steering device includes an electric power steering (EPS) device. The driving device is a power source which generates a driving force. Examples of the driving device include an engine, an electric motor, and an in-wheel motor. The braking device generates a braking force.

The HMI 40 is an interface for providing information to the driver of the vehicle 1 and receiving information from the driver. A request for switching autonomous driving to manual driving or the like is transmitted to the driver through the HMI 40.

The memory device 120 stores map information MAP. The map information MAP includes at least information on a lane configuration of a road on which the vehicle 1 travels. A lane change section (see FIGS. 1 and 2) may be registered in advance in the map information MAP. In addition, the map information MAP may include information on a shape of a road, an altitude of a road, a structure around the road, a structure between roads, and the like. The map information MAP may include information on a target-invisible section described later. The map information MAP may be acquired in advance and stored in the memory device 120 or may be acquired from an external server via the communication device 130 while the vehicle 1 is traveling.

A vehicle control program PROG is a computer program for controlling the vehicle 1. By the processor 110 executing the vehicle control program PROG, various processes by the vehicle control system 10 are realized. The vehicle control program PROG is stored in the memory device 120. Alternatively, the vehicle control program PROG may be stored in a computer-readable storage medium.

The processor 110 acquires driving environment information 200, which indicates driving environment of the vehicle 1, using the sensor group 20. The driving environment information 200 is stored in the memory device 120.

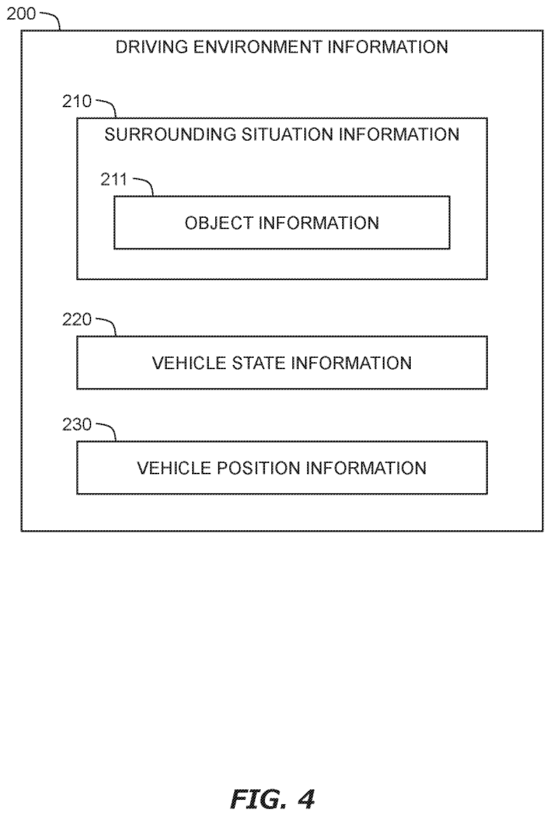

FIG. 4 is a block diagram showing an example of the driving environment information 200. The driving environment information 200 includes surrounding situation information 210, vehicle state information 220, and vehicle position information 230.

The surrounding situation information 210 is information indicating a situation around the vehicle 1. The processor 110 recognizes the surrounding situation of the vehicle 1 using the recognition sensor 21 and acquires the surrounding situation information 210. For example, the surrounding situation information 210 includes image information obtained by the camera. As another example, the surrounding situation information 210 includes point group information obtained by the LIDAR.

The surrounding situation information 210 includes object information 211 related to an object around the vehicle 1. Examples of the object include a pedestrian, another vehicle, a road structures, a white line, a zebra zone, a traffic light, a traffic sign, and an obstacle. Examples of another vehicle include a preceding vehicle, a following vehicle, a vehicle traveling in a lane near the first lane L1. The object information 211 indicates a relative position and a relative speed of the object against the vehicle 1. For example, by analyzing the image information obtained by the camera, the object can be identified and the relative position of the object can be calculated. As another example, based on the point group information obtained by the LIDAR, the object can be identified and the relative position and the relative speed of the object can be acquired.

The vehicle state information 220 is information indicating a state of the vehicle 1. The processor 110 acquires the vehicle state information 220 from the vehicle state sensor. The vehicle state information 220 may indicate a driving state (autonomous driving/manual driving) of the vehicle 1.

The vehicle position information 230 is information indicating a current position of the vehicle 1. The processor 110 acquires the vehicle position information 230 from the result of the detection by the position sensor. Further, the processor 110 may acquire the highly accurate vehicle position information 230 by a known localization process using the object information 211 and the map information MAP.

The processor 110 controls traveling of the vehicle 1. Controlling traveling includes a steering control, a driving control, and a braking control. The processor 110 controls traveling by controlling the traveling device 30 (the steering device, the driving device, and the braking device).

The processor 110 may control the autonomous driving of the vehicle 1. More specifically, the processor 110 generates a travel plan of the vehicle 1 based on the map information MAP and the driving environment information 200. Examples of the travel plan include keeping the currently traveling lane, changing lanes, turning right or left, and avoiding the obstacle. Then, the processor 110 generates a target trajectory required for the vehicle 1 to travel in accordance with the travel plan based on the map information MAP and the driving environment information 200. The target trajectory includes a target position and a target speed. Then, the processor 110 controls traveling of the vehicle 1 such that the vehicle 1 follows the target trajectory.

### 3. Advance Deceleration Control

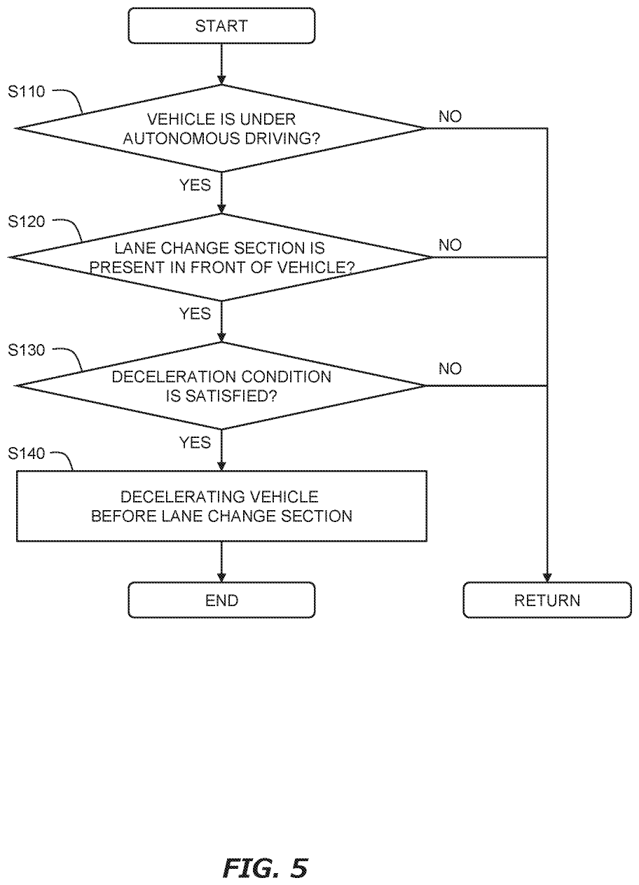

FIG. 5 is a flowchart showing processing related to the advance deceleration control executed by the processor 110 of the vehicle control system 10. The processing shown in the flowchart is realized by the processor 110 executing the vehicle control program PROG.

In Step S110, the processor 110 determines whether the vehicle 1 is in the autonomous driving state or not. When the vehicle 1 is in the autonomous driving state (Step S110; Yes), the processing proceeds to Step S120. On the other hand, when the vehicle 1 is not in the autonomous driving state (Step S110; No), the processing returns to Step S110. The processor 110 can determine whether the vehicle 1 is in the autonomous driving state or not by acquiring the vehicle state information 220 stored in the memory device 120.

In Step S120, the processor 110 determines whether the lane change section is present within a predetermined distance ahead of the vehicle 1 or not. When the lane change section is present (Step S120; Yes), the processing proceeds to Step S130. On the other hand, when the lane change section is not present (Step S120; No), the processing returns to Step S110.

The lane change section can be identified based on the lane configuration indicated by the map information MAP. Alternatively, the lane change section may be registered in advance in the map information MAP. The current position of the vehicle 1 can be acquired from the vehicle position information 230. Therefore, the processor 110 can determine whether the lane change section is present in front of the vehicle 1 or not based on the map information MAP and the vehicle position information 230.

In Step S130, the processor 110 determines whether the deceleration condition is satisfied or not. Various examples of the deceleration condition will be described later. When the deceleration condition is satisfied (Step S130; Yes), the processing proceeds to Step S140. On the other hand, when the deceleration condition is not satisfied (Step S130; No), the processing returns to Step S110.

In Step S140, the processor 110 decelerates the vehicle 1 before the lane change section. More specifically, the processor 110 controls the braking device of the traveling device 30 to generate the braking force and decelerate the vehicle 1.

The point at which the processor 110 starts to decelerate the vehicle 1 may be determined to be a point a predetermined distance before (for example, 30 m before) the starting point of the lane change section. As described above, the lane change section is obtained from the map information MAP. The current position of the vehicle 1 is obtained from the vehicle position information 230. Therefore, the processor 110 can determine the timing to start decelerating the vehicle 1 based on the map information MAP and the vehicle position information 230.

Alternatively, the processor 110 may determine the point at which the vehicle 1 is started to decelerate such that the deceleration of the vehicle 1 is started a predetermined time (for example, three seconds) before the vehicle 1 reaches the lane change section. As described above, the lane change section is obtained from the map information MAP. A current position of vehicle 1 is obtained from the vehicle position information 230. A speed of the vehicle 1 is obtained from the vehicle state information 220. Accordingly, the processor 110 can predict the time until the vehicle 1 reaches the lane change section based on the map information MAP, the vehicle state information 220, and the vehicle position information 230 and can determine the timing to start decelerating the vehicle 1.

After the vehicle 1 is decelerated, the processing of FIG. 5 ends. The autonomous driving system controls the autonomous driving. For example, in a case where the vehicle 2 which is likely to merge into the first lane L1 is present in the second lane L2, the control of the vehicle 1 is performed assuming the lane change of the vehicle 2. When there is not a vehicle which is likely to merge into the first lane L1, the vehicle 1 is continued to be driven by normal control.

Hereinafter, various examples of the deceleration condition in Step S130 will be described.

### 4. First Embodiment

In the first embodiment, the deceleration condition includes a “terrain condition”. The terrain condition is a condition that a “target-invisible section” is present before the lane change section. The target-invisible section in this specification is a section in which the second lane L2 is invisible from the vehicle 1 traveling in the first lane L1. That the second lane L2 is invisible from the vehicle 1 means that the recognition sensor 21 cannot recognize (detect) the presence of the vehicle 2 traveling in the second lane L2.

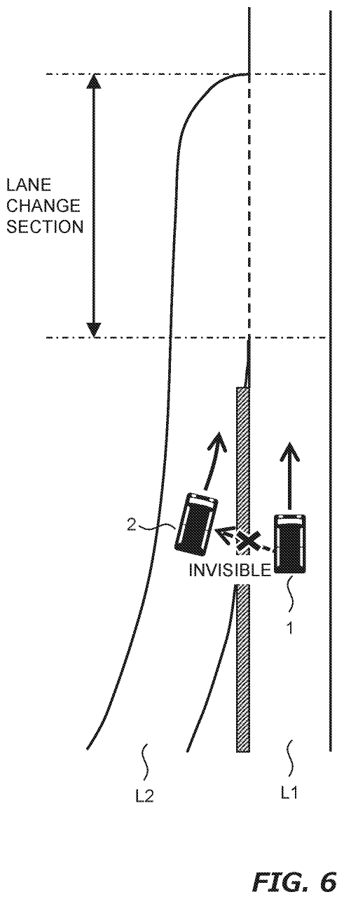

FIG. 6 is a diagram illustrating an example of the target-invisible section. In the example of FIG. 6, a wall that physically separates the first lane L1 and the second lane L2 is present before the lane change section. Due to the presence of the wall, the recognition sensor 21 of the vehicle 1 cannot recognize the vehicle 2 traveling in the second lane L2. One example of the target-invisible section is a section like this in which the vehicle 1 cannot recognize the second lane L2 due to a presence of a structure such as the wall between the first lane L1 and the second lane L2. The target-invisible section may include not only a section in which the structure physically separating the first lane L1 and the second lane L2 is continuously present but also a section in which the vehicle 1 cannot recognize the second lane L2 due to an intermittent presence of the structure.

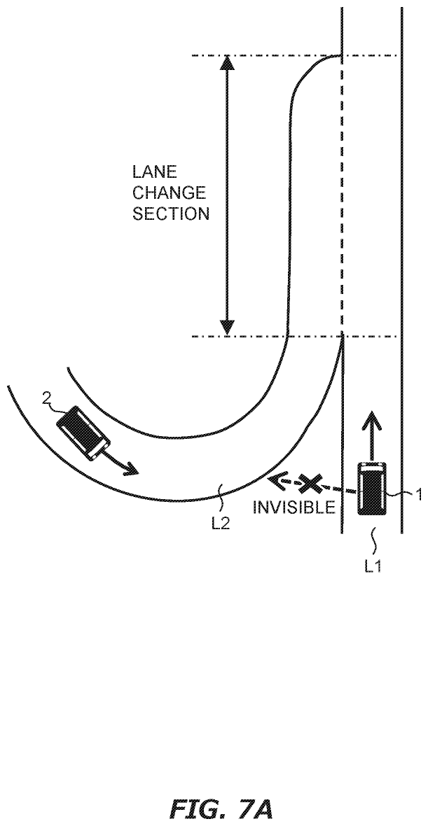

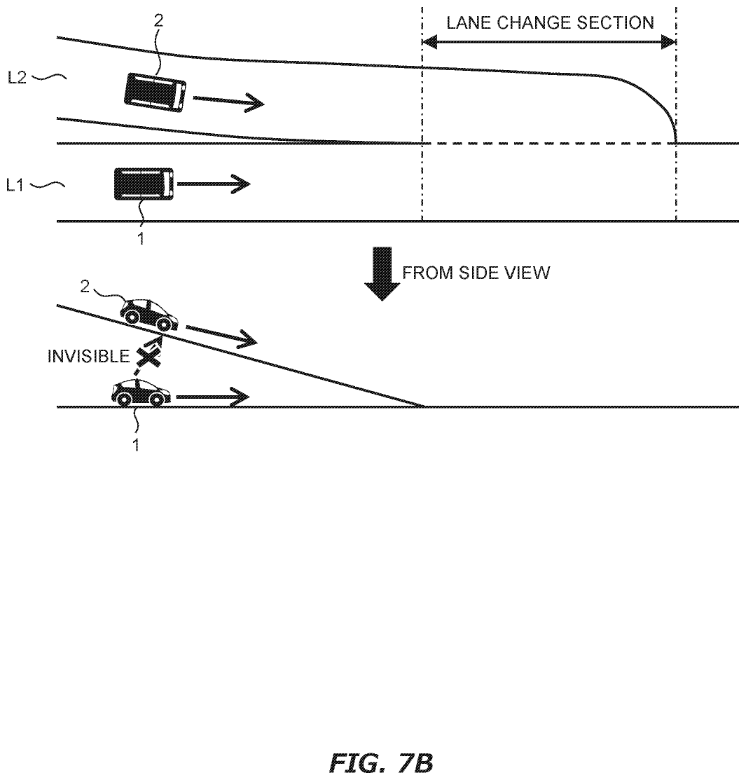

FIGS. 7A and 7B are diagrams illustrating other examples of the target-invisible section. In FIG. 7A, it is difficult for the vehicle 1 to recognize the second lane L2 since the second lane L2 is curved before the lane change section. Similarly, it is also difficult for the vehicle 1 to recognize the second lane L2 when the first lane L1 is curved before the lane change section. A section in which the first lane L1 or the second lane L2 is curved is also included in the target-invisible section.

In FIG. 7B, since the altitude of the second lane L2 is higher than the altitude of the first lane L1, it is difficult for the vehicle 1 traveling in the first lane L1 to recognize the second lane L2. Similarly, when the altitude of the first lane L1 is higher than the altitude of the second lane L2, it is difficult for the vehicle 1 to recognize the second lane L2. A section in which the first lane L1 and the second lane L2 are different in height is also included in the target-invisible section.

The autonomous driving system can start determination of whether to yield to the vehicle 2 traveling in the second lane L2 or not only after recognizing the vehicle 2 by the recognition sensor 21. If the target-invisible section is not present, the autonomous driving system can determine whether the vehicle 2 is present in the second lane L2 before reaching the lane change section by sensing the second lane L2 by the recognition sensor 21. Then, if the vehicle 2 is present, the autonomous driving system can acquire a position and a speed of the vehicle 2 in advance as the object information 211. The autonomous driving system can predict the movement of the vehicle 1 at the time of reaching the lane change section in advance based on the acquired information and can control the vehicle 1 in advance so as to adjust the vehicle speed in accordance with the determination.

However, when the target-invisible section is present before the lane change section, the recognition sensor 21 cannot recognize the vehicle 2 until the target-invisible section ends. Therefore, the autonomous driving system cannot start the determination until immediately before the vehicle 1 gets to the lane change section. It causes that the vehicle 1 enters the lane change section before the autonomous driving system controls the vehicle speed considering the presence of the vehicle 2, and there is a possibility that the control of the vehicle 1 cannot be performed in time until the end of the lane change section and contact between the vehicle 1 and the vehicle 2 occurs.

Therefore, when the target-invisible section is present before the lane change section, the vehicle 1 is decelerated in advance to secure longer time for the determination of the autonomous driving system. In the first embodiment, by setting the terrain condition as the deceleration condition, the vehicle 1 can be decelerated when it is necessary. In this way, by decelerating the vehicle 1, time for determination by the autonomous driving system can be sufficiently secured and thus it is possible to improve safety of traveling of the vehicle 1.

In some cases, after the vehicle 1 enters the lane change section, the autonomous driving system determines that the autonomous driving system cannot perform control by itself and requires the driver's intervention or switching to the manual driving. Even in such cases, it is possible to prevent that too hurried operation is required from the driver and enhance safety of traveling of the vehicle 1 since the vehicle 1 is decelerated in advance.

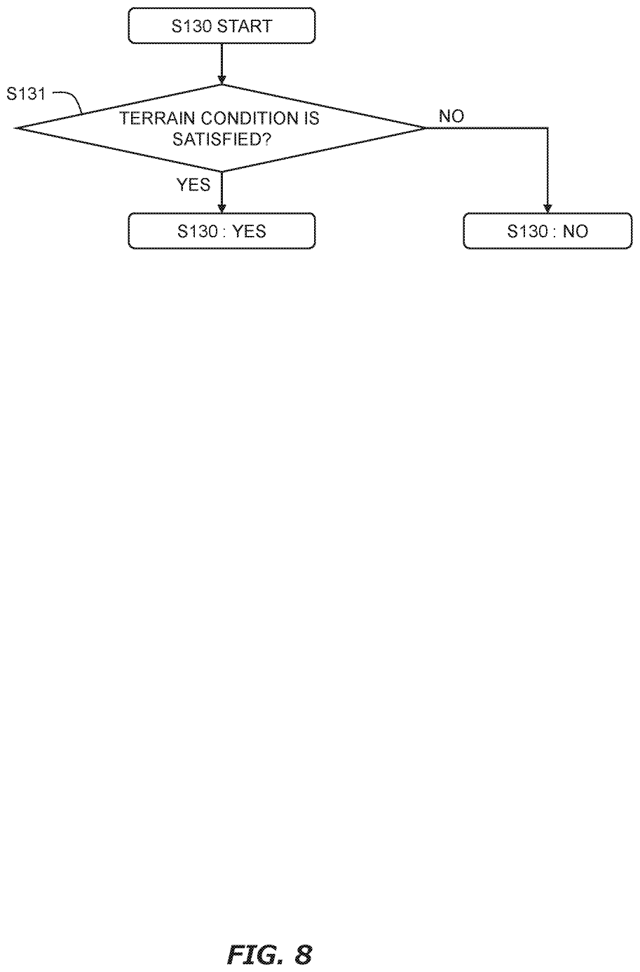

FIG. 8 is a flowchart showing an example of Step S130 in the first embodiment. In Step S131, the processor 110 determines whether the terrain condition that the target-invisible section is present before the lane change section is satisfied or not. When the terrain condition is satisfied (Step S131; Yes), it is determined that the deceleration condition is satisfied (Step S130; Yes). On the other hand, when the terrain condition is not satisfied (Step S131; No), it is determined that the deceleration condition is not satisfied (Step S130; No).

In Step S131, the processor 110 may determine where the target-invisible section is present based on the map information MAP or based on the object information 211 acquired by the recognition sensor 21.

When it is determined based on the map information MAP, information about the target-invisible section may be directly acquired from the map information MAP. Alternatively, the processor 110 may detect the target-invisible section using information about, for example, a shape, a structure, and an altitude of a road included in the map information MAP. For example, when the presence of the wall (see FIG. 6) that physically separates the first lane L1 and the second lane L2 is registered in the map information MAP, the processor 110 can acquire the position of the target-invisible section from the map information MAP. By determining the position of the target-invisible section based on the map information MAP, the processor 110 can determine the position of the target-invisible section in advance.

When using the information acquired by the recognition sensor 21, the processor 110 may detect the target-invisible section as follows, for example. The processor 110 acquires the position of the second lane L2 from the map information MAP. Then, the processor 110 senses toward the second lane L2 using the recognition sensor 21, and when the circumstances of the second lane L2 cannot be recognized, the processor 110 determines that the vehicle 1 is traveling in the target-invisible section. By using the information acquired by the recognition sensor 21, it is possible to make a determination more suitable for the current situation. Alternatively, the processor 110 may determine the target-invisible section by using both the map information MAP and the result of the recognition by the recognition sensor 21.

### 5. Second Embodiment

The second embodiment is a modified example of the first embodiment. Description overlapping with the first embodiment will be appropriately omitted.

In the second embodiment, a restriction speed is taken into consideration. When the speed of the vehicle 1 traveling before the lane change section is higher than the restriction speed, the vehicle 1 is decelerated to the restriction speed. On the other hand, when the speed of the vehicle 1 is equal to or less than the restriction speed, the vehicle 1 is not decelerated. As a result, it is possible to prevent unnecessary deceleration when the speed of the vehicle 1 is not high before the vehicle 1 gets to the lane change section and to reduce annoyance to the occupant of the vehicle 1.

The restriction speed is determined as the following examples. In the first example, the restriction speed is set in consideration of the necessary time for determination and control of the autonomous driving system. The time that the autonomous driving system can use for determination and control while the vehicle 1 travels in the lane change section is equal to “the distance D of the lane change section” divided by “the speed of the vehicle 1 traveling in the lane change section”. It means that if the speed of the vehicle 1 traveling in the lane change section is the same, time that the autonomous driving system can use becomes shorter as the distance D becomes shorter. Thus, the restriction speed is determined in accordance with the distance D such that the restriction speed decreases as the distance D decreases. In this way, it is possible to secure the sufficient time for determination of the autonomous driving system even when the distance D of the lane change section is short. A lower limit may be set in advance for the restriction speed, which is calculated by the processor 110, such that the speed of the vehicle 1 does not become extremely low. When the restriction speed is calculated based on the distance D, the processor 110 can acquire the distance D from the map information MAP.

In the second example, the restriction speed is determined in accordance with whether the following vehicle is present on the first lane L1 within a first distance behind the vehicle 1 or not. It can be determined whether the following vehicle is present based on the object information 211. The restriction speed is determined to be lower when the following vehicle is not present than when the following vehicle is present. By determining the restriction speed to be relatively high when the following vehicle is present, it is possible to reduce influence of deceleration of the vehicle 1 on the following vehicle and reduce the accompanying risk of a rear-end collision of the following vehicle. On the other hand, when it is not necessary to consider the influence on the following vehicle, securing the time for determination of the autonomous driving system can be prioritized.

The first distance may be a predetermined constant distance or may be a distance that is changed according to the situation of the vehicle 1 or the surroundings, for example, according to the speed of the vehicle 1. The first distance is set because it is considered that even when the following vehicle is present on the first lane L1 behind the vehicle 1, influence of deceleration of the vehicle 1 is small when the distance between the following vehicle and the vehicle 1 is sufficiently large When the following vehicle is present more than first distance behind, the restriction speed is calculated to be the same as in the case where the following vehicle is not present.

In the third example, the restriction speed is determined based on both the distance D and whether the following vehicle is present within the first distance behind the vehicle 1. By considering both the distance D and whether the following vehicle is present, it is possible to set the restriction speed more suitable for the situation.

In the fourth example, the restriction speed is a predetermined constant vehicle speed. In this case, since the processor 110 does not need to calculate the restriction speed, it is possible to reduce a load of processing on the processor 110.

In the second embodiment, by setting the restriction speed, it is possible to suppress unnecessary deceleration of the vehicle 1 and reduce annoyance to the occupant of the vehicle 1 and influence on a peripheral vehicle, particularly the following vehicle.

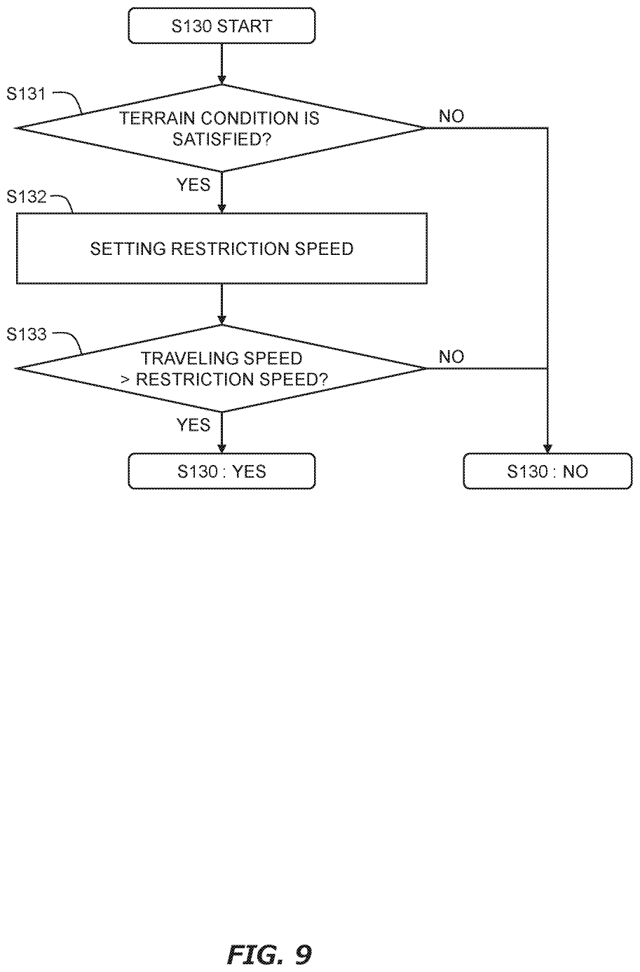

FIG. 9 is a flowchart showing an example of Step S130 in the second embodiment. A process of Step S131 is the same as the process of Step S131 in the flowchart of FIG. 8. When the terrain condition is satisfied (Step S131; Yes), the processing proceeds to Step S132.

In Step S132, the processor 110 sets the restriction speed. The restriction speed set in Step S132 may be a predetermined constant speed or may be a vehicle speed determined based on the distance D, whether the vehicle following the vehicle 1 is present, or both of them.

In Step S133, the processor 110 determines whether the current traveling speed of the vehicle 1 is higher than the restriction speed or not. The current traveling speed of the vehicle 1 is acquired from the vehicle state information 220. When the traveling speed is higher than the restriction speed (Step S133; Yes), it is determined that the deceleration condition is satisfied (Step S130; Yes). On the other hand, when the traveling speed is equal to or less than the restriction speed (Step S133; No), it is determined that the deceleration condition is not satisfied (Step S130; No).

### 6. Third Embodiment

The third embodiment is also a modified example of the first embodiment. Description overlapping with the first embodiment will be appropriately omitted.

In the third embodiment, the vehicle 1 is decelerated only when the following vehicle is not present, and the vehicle 1 is not decelerated when the following vehicle is present. Accordingly, it is possible to reduce annoyance to the following vehicle caused by deceleration of the vehicle 1 and reduce possibility of rear-end collision caused by unexpected deceleration for the following vehicle.

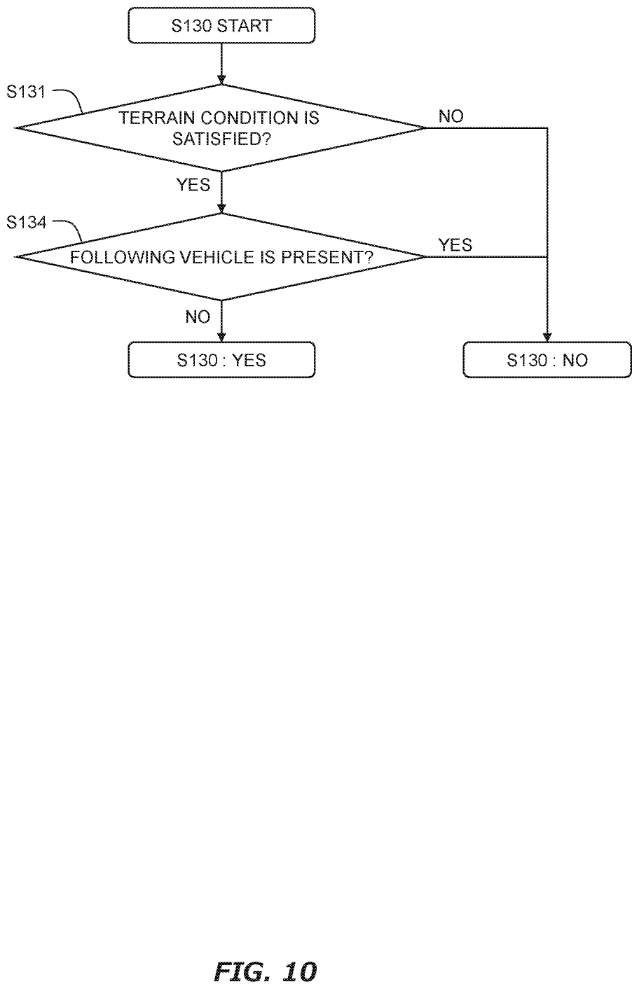

FIG. 10 is a flowchart showing an example of Step S130 in the third embodiment. A process of Step S131 is the same as the process of Step S131 in the flowchart of FIG. 8. When the terrain condition is satisfied (Step S131; Yes), the processing proceeds to Step S134.

In Step S134, the processor 110 determines whether the following vehicle is present on the first lane L1 within the first distance behind the vehicle 1 or not. When the following vehicle is not present (Step S134; No), it is determined that the deceleration condition is satisfied (Step S130; Yes). On the other hand, when the following vehicle is present (Step S134; Yes), it is determined that the deceleration condition is not satisfied (Step S130; No). In Step S134, the processor 110 can determine whether the following vehicle is present based on the object information 211.

The reason for determining whether the following vehicle is present within the first distance behind the vehicle 1 is the same as when the restriction speed is calculated in the second embodiment. When the distance between the vehicle 1 and the following vehicle is sufficiently large, it is considered that the influence of deceleration of the vehicle 1 on the following vehicle is small, so the deceleration control is performed in the same manner as in the case where there is no following vehicle. The first distance may be a predetermined constant distance or may be a distance determined in accordance with the situation of the vehicle 1 or the surroundings, for example, the speed of the vehicle 1.

### 7. Fourth Embodiment

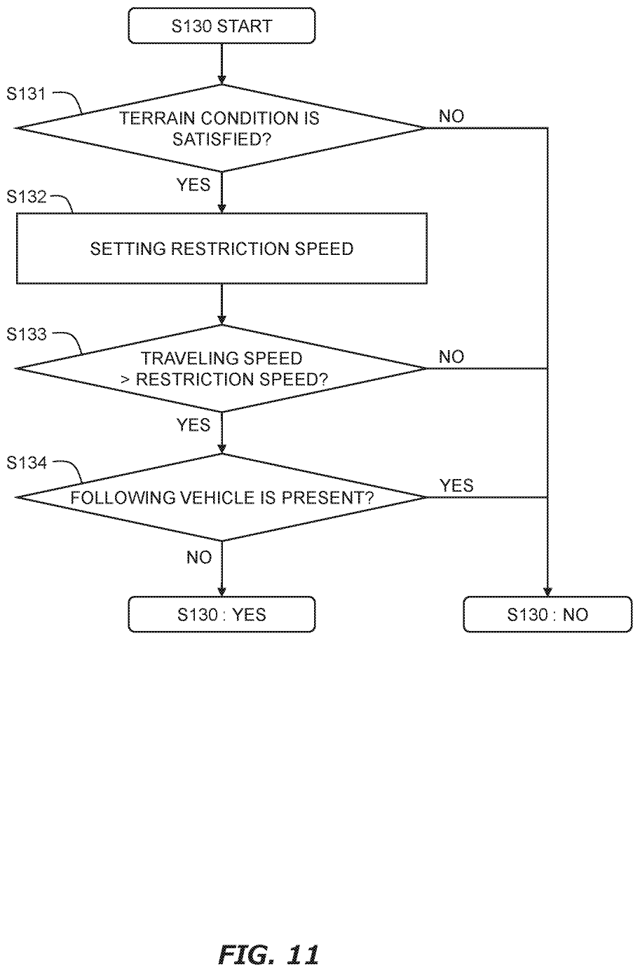

FIG. 11 is a flowchart showing an example of Step S130 in the fourth embodiment. The fourth embodiment is a combination of the second embodiment shown in FIG. 9 and the third embodiment shown in FIG. 10.

### 8. Fifth Embodiment

The fifth embodiment is a modified example of the first and second embodiments. Description overlapping with the first and second embodiments will be appropriately omitted. The deceleration condition is the same as that in the first or second embodiment.

In the fifth embodiment, a manner of decelerating the vehicle 1 when the deceleration condition is satisfied is changed depending on whether the following vehicle is present or not. When the deceleration condition is satisfied and the following vehicle is present, the processor 110 controls the vehicle 1 such that the vehicle 1 starts to decelerate earlier than when the following vehicle is not present and a deceleration degree does not become large.

In the case where the following vehicle is present, there is a possibility that, if the vehicle 1 is rapidly decelerated, the driver of the following vehicle feels annoyed or the following vehicle collide with the vehicle 1 due to delay of respond to the deceleration of the vehicle 1. In the fifth embodiment, these risks are avoided. Specifically, the vehicle 1 is started to decelerate earlier and an upper limit is set to the deceleration degree to prevent sudden deceleration when the following vehicle is present.

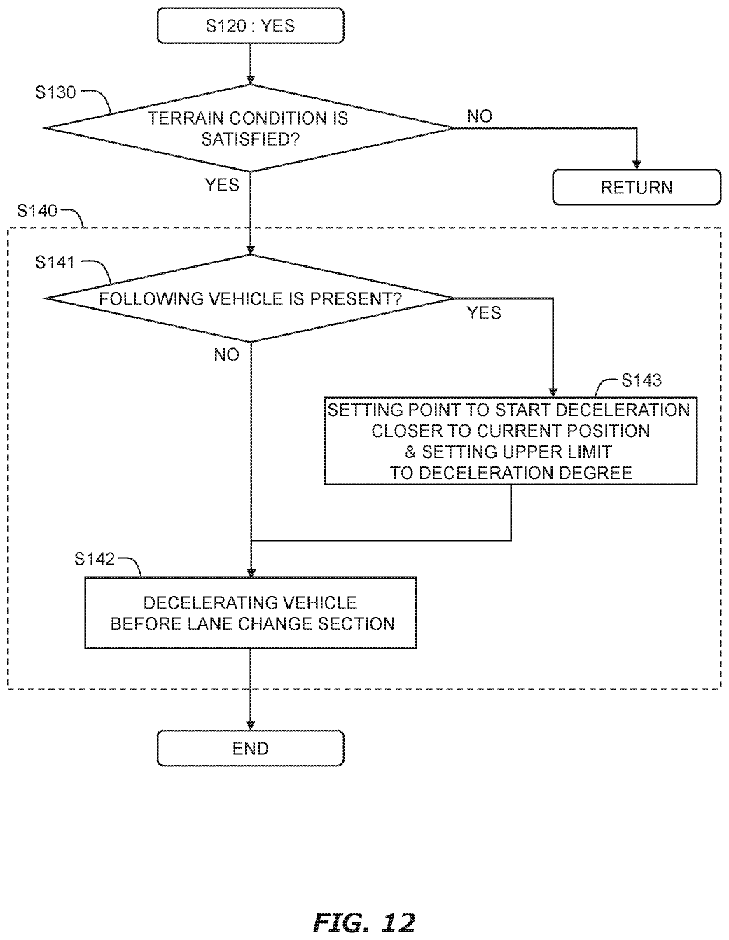

FIG. 12 is a flowchart showing an example of processing executed by the processor 110 in the fifth embodiment.

In Step S130, a process same as the Step S130 shown in the flowchart of either FIG. 8 or FIG. 9 is executed and the determination regarding the deceleration condition is performed. When the deceleration condition is satisfied (Step S130; Yes), the processing proceeds to Step S141.

Processes of Step S141 to Step S143 are processes relating to the deceleration of the vehicle 1. They correspond to Step S140 in the flowchart of FIG. 5. In Step S141, the processor 110 determines whether the following vehicle is present on the first lane L1 within the first distance behind the vehicle 1. When the following vehicle is not present (Step S141; No), the processing proceeds to Step S142. On the other hand, when the following vehicle is present (Step S141; Yes), the processing proceeds to Step S143.

A reason why the processor 110 takes the first distance into consideration when determining whether the following vehicle is present in Step S141 is the same as the reason for determining whether the following vehicle is present within the first distance behind the vehicle 1 in the second and the third embodiments. When the vehicle 1 and the following vehicle are sufficiently away from each other, it is considered that the influence on the following vehicle is small, so the same deceleration control as when the following vehicle is not present is performed.

In Step S143, the processor 110 sets a point at which the vehicle 1 starts to decelerate such that the vehicle 1 starts to decelerate earlier than when the following vehicle is not present. For example, if the vehicle 1 is started to decelerate 30 m before the starting point of the lane change section when the following vehicle is not present, the vehicle 1 is started to decelerate 50 m before the starting point of the lane change section. As another example, if the vehicle 1 is started to decelerate three seconds before the vehicle 1 reaches the lane change section when the following vehicle is not present, the vehicle 1 is started to decelerate five seconds before the vehicle 1 reaches the lane change section. In addition, the processor 110 also sets an upper limit of the deceleration degree while setting the point at which the vehicle 1 is started to decelerate.

In Step S142, the processor 110 decelerates the vehicle 1 before the lane change section. Regardless of presence or absence of the following vehicle, it is the same in terms of decelerating the vehicle 1. However, in a case where the following vehicle is present, the vehicle 1 is started to decelerate at a point closer to the current position (the point set in Step S143). Then, the vehicle 1 is controlled to decelerate more slowly than when the following vehicle is not present.

### 9. Application Example

In the first to fifth embodiments, when the deceleration condition is satisfied, the processor 110 may perform the lateral direction control while performing the deceleration control. In the lateral direction control, the processor 110 may set a position in the lateral direction of the vehicle 1 and control the vehicle 1 to travel at a position farther from the second lane L2 than the center of the first lane L1 is. Accordingly, even if the vehicle 1 and the vehicle 2 travels side by side and the vehicle 2 merges into the first lane L1 performing the unreasonable lane change, it is possible to reduce a risk of contact between the vehicle 1 and the vehicle 2.

### 10. Effect

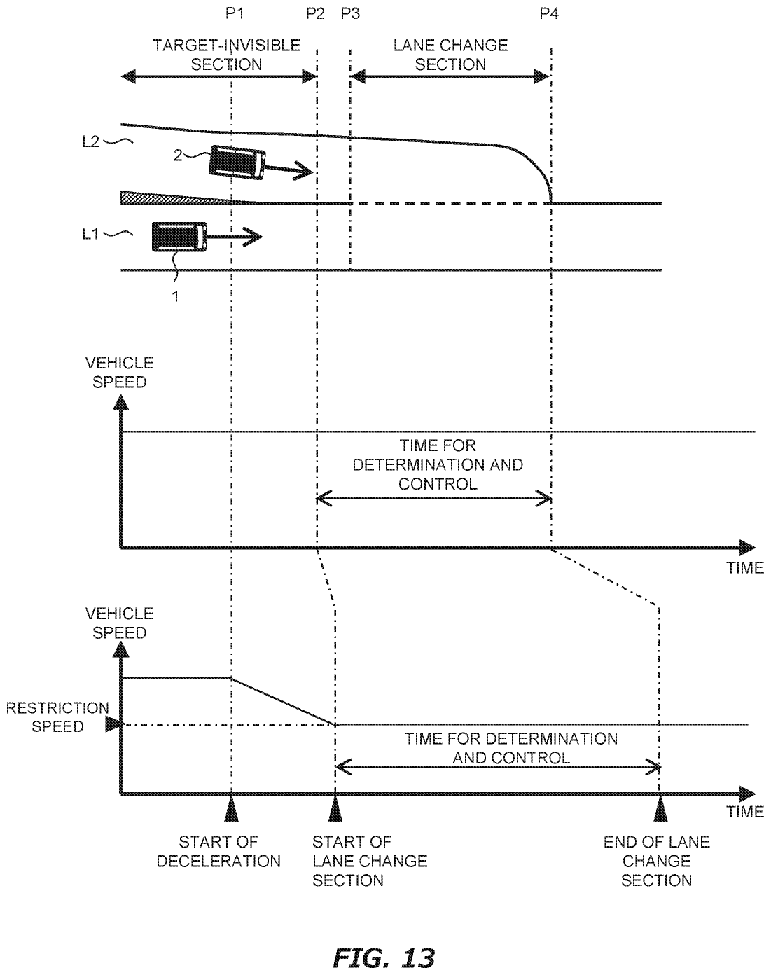

FIG. 13 shows time charts for explaining the effect of the advance deceleration control by the vehicle control system 10. The upper time chart shows a change of the speed of the vehicle 1 in a case where the advance deceleration control is not performed by the vehicle control system 10, and the lower time chart is a time chart in the case where the advance deceleration control is performed. The lane change section is a section between the point P3 and the point P4.

In the upper time chart, the speed of vehicle 1 is the same before and after entering the lane change section. On the other hand, in the lower time chart, the vehicle 1 is started to decelerate at the point P1 before the lane change section, and the vehicle 1 is decelerated to the restriction speed when entering the lane change section. Since the vehicle speed is lowered, the vehicle control system 10 can use longer time for determination in the lower time chart.

As described above, according to the advance deceleration control performed by the vehicle control system 10, it is possible to secure the sufficient time for determination even when the target-invisible section is present before the lane change section and the autonomous driving system cannot perform the determination in advance. As a result, a risk of contact with another vehicle can be reduced, and safety of traveling of the vehicle 1 can be enhanced. In addition, since it is not necessary to switch to the manual driving and require operation of the driver every time when the lane change section is present, it is also possible to reduce annoyance to the driver.

In addition, the advance deceleration control is useful not only in a situation in which the vehicle 2 are likely to change lanes in the lane change section but also in a situation in which the vehicle 1 changes lanes and merges into the second lane L2. The advance deceleration control can be also applied to a case where the second lane L2 is the main lane and the first lane L1 in which the vehicle 1 travels merges with the second lane L2 in the merging section. In such a case, it is also possible to secure a long time for determining whether to perform the lane change in front of or behind the vehicle 2 traveling in the second lane L2 by decelerating the vehicle 1 before the vehicle 1 enters the lane change section. As a result, the traveling safety of the vehicle 1 can be enhanced.

However, the control by the vehicle control system 10 is particularly effective when the first lane L1 in which the vehicle 1 travels is a lane to be merged with. This is because it is more difficult to predict the motion of the other vehicle traveling in the merging lane than to predict that of the other vehicle traveling in the lane to be merged with, and it becomes more important to secure time for the determination.

What is claimed is:

1. A vehicle control system for controlling a vehicle that performs autonomous driving, the vehicle control system comprising one or more processors, wherein
a first lane is a traffic lane in which the vehicle travels,
a second lane is a traffic lane adjacent to the first lane in a lane change section of less than a predetermined distance,
a lane change between the first lane and the second lane is permitted in the lane change section,
the one or more processors are configured to decelerate the vehicle before the lane change section when the lane change section is present in front of the vehicle and a deceleration condition is satisfied during the autonomous driving of the vehicle, and
the deceleration condition includes at least a terrain condition that a target-invisible section in which the second lane is invisible from the vehicle is present before the lane change section.

2. The vehicle control system according to claim 1, wherein
the lane change section is a merging section where the first lane and the second lane merge together.

3. The vehicle control system according to claim 1, wherein
at least any one of the following is satisfied in the target-invisible section:
a structure that physically separates the first lane and the second lane is present;
at least one of the first lane and the second lane has a curved shape; and
the first lane and the second lane are different in height.

4. The vehicle control system according to claim 1, wherein
the one or more processors are further configured to determine whether or not the target-invisible section is present before the lane change section based on map information or a result of recognition by a recognition sensor mounted on the vehicle.

5. The vehicle control system according to claim 1, wherein
the deceleration condition further includes that a speed of the vehicle is higher than a restriction speed.

6. The vehicle control system according to claim 5, wherein
the restriction speed is a predetermined constant speed.

7. The vehicle control system according to claim 5, wherein
the restriction speed is set based on at least a length of the lane change section and to be lower as the length of the lane change section is shorter.

8. The vehicle control system according to claim 5, wherein
the restriction speed is set according to whether or not a following vehicle is present on the first lane within a first distance behind the vehicle, and
the restriction speed is lower when the following vehicle is not present than when the following vehicle is present.

9. The vehicle control system according to claim 1, wherein
the deceleration condition further includes that a following vehicle is not present on the first lane within a first distance behind the vehicle.

10. The vehicle control system according to claim 1, wherein the one or more processors are further configured to:
determine whether or not a following vehicle is present on the first lane within a first distance behind the vehicle; and
start decelerating the vehicle earlier when the deceleration condition is satisfied and the following vehicle is present than when the following vehicle is not present.

11. A vehicle control method for controlling a vehicle that performs autonomous driving, wherein
a first lane is a traffic lane in which the vehicle travels,
a second lane is a traffic lane adjacent to the first lane in a lane change section of less than a predetermined distance,
a lane change between the first lane and the second lane is permitted in the lane change section,
the vehicle control method comprises decelerating the vehicle before the lane change section when the lane change section is present in front of the vehicle and a deceleration condition is satisfied during the autonomous driving of the vehicle, and
the deceleration condition includes at least a terrain condition that a target-invisible section in which the second lane is invisible from the vehicle is present before the lane change section.
